(19) United States
(12) Patent Application Publication
(10) Pub. No.: US 2026/0296448 A1
(43) Pub. Date: Oct. 1, 2026

(54) DETECTION AND CLASSIFICATION OF PROSOCIAL BEHAVIORS

(71) Applicant: Honda Motor Co., Ltd., Tokyo (JP)

(72) Inventors: Zhaobo ZHENG, Campbell, CA (US); Kumar AKASH, San Jose, CA (US); Teruhisa MISU, San Jose, CA (US); Meng WANG, San Jose, CA (US)

(21) Appl. No.: 19/093,158

(22) Filed: Mar. 27, 2025

(51) Int. Cl. B60W 40/09; B60W 40/08

(52) U.S. Cl. CPC B60W 40/09; B60W 2040/0872; B60W 2420/403

(57) ABSTRACT

A mobility system for detecting and classifying a prosocial behavior of a driver driving a vehicle may include a memory storing one or more instructions, and a processor executing one or more of the instructions stored on the memory to perform one or more acts, actions, and/or steps. For example, the processor may perform collecting a dataset from at least one sensor, extracting multimodal features and contextual features from the dataset, detecting, by a first AI model, a prosocial behavior of the driver based on the extracted multimodal features, classifying, by a second AI model, the detected prosocial behavior into a respective one of a plurality of levels of each of a plurality of psychological factors linked to the detected prosocial behavior, and conducting one of multiple promotion measures to promote the prosocial behavior based on a respective level of each of the plurality of the psychological factors.

### TECHNICAL FIELD

The present disclosure relates to apparatuses and methods for detecting driver's prosocial behaviors using naturalistic driving data, and categorizing the detected prosocial behaviors based on psychological factors including motivation, effort, and satisfaction.

### BACKGROUND

In the context of driving and micro-mobility, prosocial behaviors are actions that drivers take to benefit other road users, such as other drivers, pedestrians, or bicyclists, often at the expense of their own time and space. Examples of prosocial behaviors include yielding, observing, gentle overtaking, and increasing space. Prosocial behaviors in traffic may promote harmonious interaction, social acceptance, and the wellbeing of road users including drivers, passengers, and pedestrians.

### BRIEF DESCRIPTION

According to one aspect, a mobility system for detecting and classifying a prosocial behavior of a driver driving a vehicle may include a memory storing one or more instructions, and a processor executing one or more of the instructions stored on the memory to perform one or more acts, actions, and/or steps. For example, the processor may perform collecting a dataset from at least one sensor, extracting multimodal features and contextual features from the dataset, detecting, by a first AI model, a prosocial behavior of the driver based on the extracted multimodal features, classifying, by a second AI model, the detected prosocial behavior into a respective one of a plurality of levels of each of a plurality of psychological factors linked to the detected prosocial behavior, and conducting one of multiple promotion measures to promote the prosocial behavior based on a respective level of each of the plurality of the psychological factors.

The dataset may include a forward video from an image capture device, eye gaze data from an eye tracking sensor, physiological data from a wearable sensor, and control area network (CAN) bus data from a CAN bus of the mobility system. The extracted multimodal features may include video clips, eye gaze signals, physiological signals, and CAN-bus signals. The contextual features may be extracted from the forward video by a large language model (LLM). The plurality of psychological factors may include obligation, effort, and satisfaction. The first AI model and the second AI model may be trained based on a plurality of video clips labeled with one of multi-level categories of each of the obligation, effort, and satisfaction. The multiple promotion measures may include providing the driver with an economical reward point to the driver when the prosocial behavior is classified as one of a medium or higher level of effort. The multiple promotion measures may include allowing the driver to access a less restrictive configuration when the prosocial behavior is classified as one of a medium or higher level of obligation. The multiple promotion measures may include providing the driver with a complimentary acknowledgement to the driver when the prosocial behavior is classified as one of a medium or higher level of satisfaction.

According to one aspect, a computer-implemented method for detecting and classifying a prosocial behavior of a driver driving a vehicle may include collecting a dataset from at least one sensor, extracting multimodal features and contextual features from the dataset, detecting, by a first AI model, a prosocial behavior of the driver based on the extracted multimodal features, classifying, by a second AI model, the detected prosocial behavior into a respective one of a plurality of levels of each of a plurality of psychological factors linked to the detected prosocial behavior, and conducting one of multiple promotion measures to promote the prosocial behavior based on a respective level of each of the plurality of the psychological factors.

The dataset may include a forward video from an image capture device, eye gaze data from an eye tracking sensor, physiological data from a wearable sensor, and control area network (CAN) bus data from a CAN bus of the mobility system. The extracted multimodal features may include video clips, eye gaze signals, physiological signals, and CAN-bus signals. The contextual features may be extracted from the forward video by a large language model (LLM). The plurality of psychological factors may include obligation, effort, and satisfaction. The first AI model and the second AI model may be trained based on a plurality of video clips labeled with one of multi-level categories of each of the obligation, effort, and satisfaction. The multiple promotion measures may include providing the driver with an economical reward point to the driver when the prosocial behavior is classified as one of a medium or higher level of effort. The multiple promotion measures may include allowing the driver to access a less restrictive configuration when the prosocial behavior is classified as one of a medium or higher level of obligation. The multiple promotion measures may include providing the driver with a complimentary acknowledgement to the driver when the prosocial behavior is classified as one of a medium or higher level of satisfaction. The second AI model may utilize a random forest tree model or a gradient boosted decision tree.

According to one aspect, a non-transitory computer readable storage medium storing instructions that when executed by a computer may include a processor to perform one or more acts, actions, and/or steps. For example, the processor may perform a computer-implemented method for detecting and classifying a prosocial behavior of a driver driving a vehicle. The computer-implemented method may include collecting a dataset from at least one sensor, extracting multimodal features and contextual features from the dataset, detecting, by a first AI model, a prosocial behavior of the driver based on the extracted multimodal features, classifying, by a second AI model, the detected prosocial behavior into a respective one of a plurality of levels of each of a plurality of psychological factors linked to the detected prosocial behavior, and conducting one of multiple promotion measures to promote the prosocial behavior based on a respective level of each of the plurality of the psychological factors.

The plurality of psychological factors may include obligation, effort, and satisfaction. The first AI model and the second AI model may be trained based on a plurality of video clips labeled with one of multi-level categories of each of the obligation, effort, and satisfaction. The multiple promotion measures may include providing the driver with an economical reward point to the driver when the prosocial behavior is classified as one of a medium or higher level of effort. The multiple promotion measures may include allowing the driver to access a less restrictive configuration when the prosocial behavior is classified as one of a medium or higher level of obligation. The multiple promotion measures may include providing the driver with a complimentary acknowledgement to the driver when the prosocial behavior is classified as one of a medium or higher level of satisfaction.

### BRIEF DESCRIPTION OF THE DRAWINGS

FIG. 1 is a block diagram illustrating an exemplary mobility system for detecting and classifying prosocial behaviors of a driver, according to one aspect.

FIG. 2 is an exemplary flow diagram of a computer-implemented method for detecting and classifying a prosocial behavior of a driver driving a vehicle, according to one aspect.

FIG. 3 illustrates one exemplary block diagram of a computer-implemented method of training the AI models in the mobility system for prosocial detection and classification, according to one aspect.

FIG. 4A illustrates an exemplary series of image frames decomposed from video clips for large language model (LLM)-based feature extraction, according to one aspect.

FIG. 4B illustrates an exemplary set of questions for a large language model (LLM) to extract contextual features from image frames and its outputs, according to one aspect.

FIG. 5 illustrates an exemplary block diagram for executing the AI models for detecting and classifying prosocial behaviors in a real driving environment, according to one aspect.

FIG. 6 illustrates an exemplary promotion measure to promote the prosocial behavior classified as one of a medium or higher level of satisfaction.

FIG. 7 is an illustration of an example computer-readable medium or computer-readable device including processor-executable instructions configured to embody one or more of the provisions set forth herein, according to one aspect.

FIG. 8 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DERS'RE), and direct RAM bus RAM (DRAME). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “dataset”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable, and non-removable media implemented in any method or technology for storage of information such as computer readable instructions, data structures, modules, or other data.

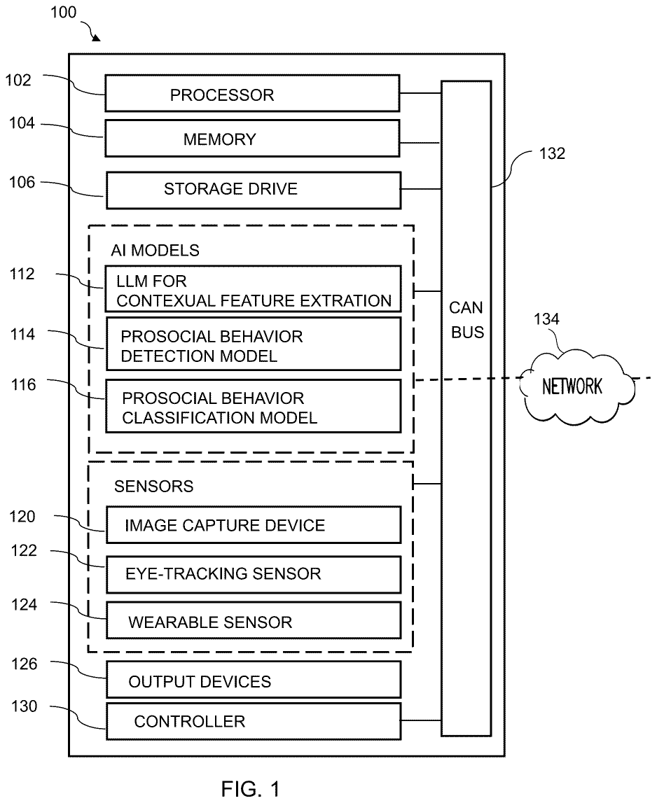

FIG. 1 is a block diagram illustrating an exemplary mobility system for detecting and classifying prosocial behaviors of a driver, according to one aspect. The mobility system 100 may include a processor 102, a memory 104, a storage drive 106, an output device 126, a controller 130, and a CAN-bus 132. The mobility system 100 also may include multiple AI models including a large language model (LLM) 112, a prosocial behavior detection model 114, and a prosocial behavior classification model 116. The AI models may be embedded in the mobility system 100 or stored on the storage drive 106. Alternatively, the AI models may be communicable with an external AI server via a network 134 and receive processed output data from the external AI server (not shown).

The mobility system 100 may be any motorized vehicle, such as a car, a truck, a motor bicycle, a scooter, a motorized wheelchair, and the like. The mobility system 100 may include various image capture devices 120 and sensors to create a dataset for detecting prosocial behaviors in driving and personal-mobility contexts. Thus, the sensors of the mobility system 100 may collect a dataset.

The processor 102 may execute one or more of the instructions stored in the memory 104 to perform one or more acts, actions, and/or steps. For example, the processor 102 may extract multimodal features and contextual features from the dataset, and perform detecting, by a first AI model (e.g., the prosocial behavior detection model 114), a prosocial behavior of the driver based on the extracted multimodal features. The processor 102 may perform classifying, by a second AI model (e.g., the prosocial behavior classification model 116), the detected prosocial behavior into a respective one of a plurality of levels of each of a plurality of psychological factors linked to the detected prosocial behavior. The first AI model and the second AI model may be trained based on a plurality of video clips labeled with one of multi-level categories of each of the obligation, effort, and satisfaction.

Also, the processor 102 may perform conducting one of multiple promotion measures to promote the prosocial behavior based on a respective level of each of the plurality of the psychological factors. The multiple promotion measures may include providing the driver with an economical reward point to the driver when the prosocial behavior is classified as one of a medium or higher level of effort. The multiple promotion measures may include allowing the driver to access a less restrictive configuration when the prosocial behavior is classified as one of a medium or higher level of obligation. The multiple promotion measures may include providing the driver with a complimentary acknowledgement to the driver when the prosocial behavior is classified as one of a medium or higher level of satisfaction.

The LLM 112 may be used to extract contextual features indicative of prosocial behaviors from a series of images. Pre-trained on internet-scale data, the LLM 112 may have an inherent structure of the world and may have the ability to perform reasoning and contextual understanding capabilities and may be capable of processing text and image inputs and outputting a generative response.

The prosocial behavior detection model 114 may be used to detect the driver's prosocial behaviors based on the extracted multimodal signals.

The prosocial behavior classification model 116 may be used to classify the detected behaviors into one of the multiple predefined levels of obligation, effort, and satisfaction. The prosocial behavior classification model (e.g., the second AI model) may utilize a random forest tree model or a gradient boosted decision tree.

The sensors may include an image capture device 120, an eye tracking sensor 122, a wearable sensor 124, etc. The eye tracking sensor 122 may detect or sense eye gaze data of the driver. The wearable sensor 124 may detect or sense physiological data of the driver. The CAN-bus 132 may be a vehicle bus standard designed to allow microcontrollers, sensors, and other devices to communicate with each other via the CAN, and may output CAN-bus data, such as a position and a velocity. In addition, the mobility system 100 may include other sensors, such as an internal momentum sensor and a global position satellite (GPS).

The output devices 126 may include displays and/or speakers to output various information, such as a complimentary message.

Respective components of the mobility system 100 for prosocial behavior detection and classification may be operably coupled or in computer communication with one another and may be operably coupled or in computer communication via the CAN-bus 132 or other communication pathway. Further, one or more of the AI models or the controller 130 may be implemented via the processor 102, the memory 104, the storage drive 106, etc. In other words, any actions, calculations, or determinations made by the AI models or the controller 130 may be performed by the processor 102 and/or the memory 104.

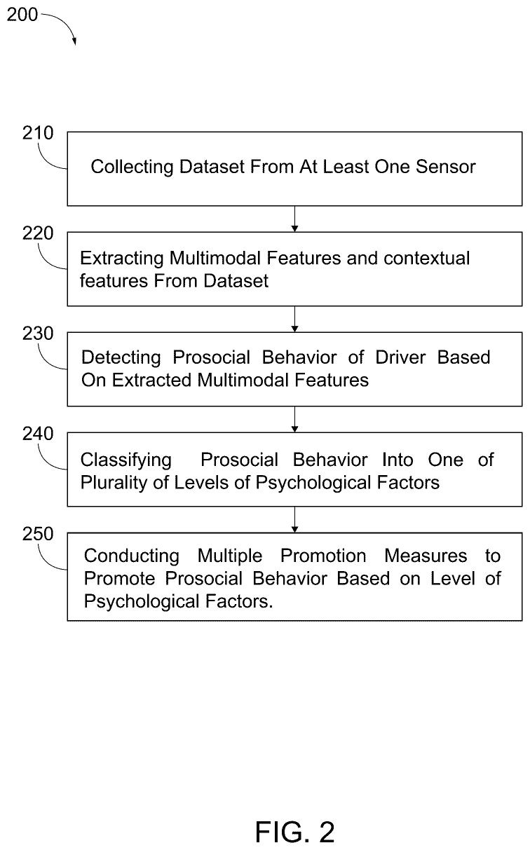

FIG. 2 is an exemplary flow diagram of a computer-implemented method 200 for detecting and classifying a prosocial behavior of a driver driving a vehicle, according to one aspect. The computer-implemented method 200 may include collecting 210 a dataset from at least one sensor, and extracting 220 multimodal features from the dataset. Then the computer-implemented method 200 may include detecting 230, by a first AI model, a prosocial behavior of the driver based on the extracted multimodal features, and classifying 240, by a second AI model, the detected prosocial behavior into a respective one of a plurality of levels of each of a plurality of psychological factors linked to the detected prosocial behavior. In addition, the computer-implemented method 200 may include conducting 250 one of multiple promotion measures to promote the prosocial behavior based on a respective level of each of the plurality of the psychological factors.

In the training stage, the first AI model may be trained based on the extracted multimodal features. The second AI model may be trained based on the extracted multimodal features, the LLM-based contextual features, and the labeled data, such as a plurality of video clips labeled with one of multi-level categories of each of the obligation, effort, and satisfaction.

In the execution stage, the conducting 250 of multiple promotion measures may include providing the driver with an economical reward point to the driver when the prosocial behavior is classified as one of a medium or higher level of the effort, allowing the driver to access a less restrictive configuration when the prosocial behavior is classified as one of a medium or higher level of obligation, and providing the driver with a complimentary acknowledgment to the driver when the prosocial behavior is classified as one of a medium or higher level of the satisfaction.

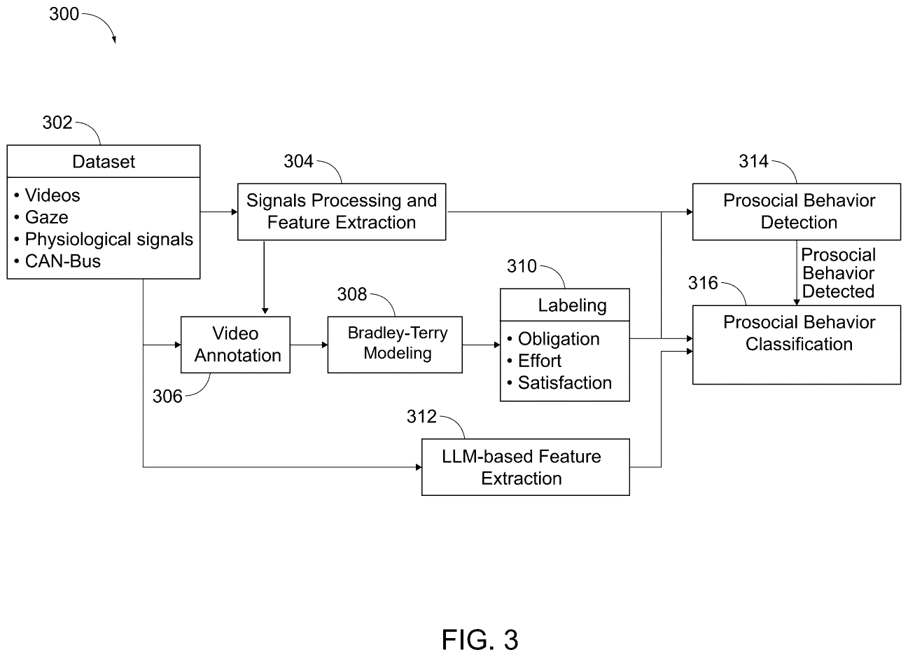

FIG. 3 illustrates one exemplary block diagram of a computer-implemented method of training the AI models in the mobility system for prosocial detection and classification, according to one aspect. In the training stage, the mobility system 100 may collect a dataset 302 and obtain annotated data in a video annotation 306. Then, the processor 102 may perform signal processing and feature extraction 304, a Bradley-Terry modeling 308, a labeling 310, an LLM-based feature extraction 312, a prosocial behavior detection 314, and a prosocial behavior classification 316.

The dataset 302 may include historical data generated from various sensors while the mobility system 100 drove on a road where pedestrians, cyclists, and vehicles passed by, and stop signs were installed at an intersection. According to one aspect, the driver of the mobility system 100 may wear a smart glass with the eye tracking sensor 122 and a glove with the wearable sensor 124.

The dataset 302 may establish a pipeline that begins with collecting large-scale forward video from the image capture device 120. The dataset 302 also may include eye gaze data output from the eye tracking sensor 122, physiological data output from the wearable sensor 124, and CAN-bus data output from the CAN-bus 132 in the mobility system 100.

According to one aspect, the eye gaze data may include gaze 2D positions and pupil diameters. The physiological data may include a heart rate (HR), galvanic skin response (GSR) levels, and semantic fixation percentages. The CAN-bus data may include the positions, linear velocities, and angular velocities of the driver's vehicle.

In the signal processing and feature extraction 304, the processor 102 may extract video clips from the video data produced by image capture device 120. Also, the processor 102 may extract physiological signals, eye gaze signals, and CAN-bus signals by using sampling windows at a regular interval. Also, the processor 102 may compute averages, standard deviations, or a minimum or maximum of the extracted features. As an example, the processor 102 may uniformly sample 30 data points from each extracted feature, covering a time window starting 5 seconds before and extending to 5 seconds after the detected behaviors.

In addition, gaze semantic features may be extracted from the videos to enhance the understanding of the contextual information of the video scenes. As an example, the signal processing and feature extraction 304 may utilize a OneFormer model or other multi-task universal image segmentation framework that unifies segmentation with a multi-task train-once design by employing a transformer architecture for vision tasks. The OneFormer model may output multiple classes, such as road, sidewalk, building, wall, fence, pole, traffic light, traffic sign, vegetation, terrain, sky, person, rider, vehicle, truck, bus, train, motorcycle, bicycle, etc. Then, the OneFormer model may extract a circular region of a predetermined number of pixels (e.g., 50 pixels) in a diameter from the center of the eye gaze point. Then, the processor 102 may compute a predominant class within this circle among the multiple classes to assign a semantic fixation type as a gaze semantic feature.

In the video annotation 306, the processor 102 may present to multiple annotators the extracted video clips in pair in the right and left sides on a screen for detecting the prosocial behaviors.

As used herein, and in the context of driving and mobility, “prosocial behaviors” may be defined as actions that drivers take to benefit other road users, such as other drivers, pedestrians, or bicyclists, often at the expense of their own time and space. With this definition of the prosocial behaviors, at least two annotators may collaborate to identify video clips exhibiting prosocial behaviors.

Subsequently, the annotators may annotate each video clip by answering the questions regarding psychological factors that affected the driver to perform the prosocial behaviors. The example questions may be as follows: 1) which prosocial behavior in the videos do you feel more obligated to act upon?; 2) which prosocial behavior in the videos do you think needed more effort to perform?; and 3) if you were the person in the prosocial behavior, in which video would you feel less happy afterward? Through this annotation process, hundreds or thousands of video clip pairs may be annotated.

In the Bradley-Terry modelling 308, the processor 102 may apply the Bradley-Terry model to the annotated video clip pairs. Based on pairwise comparisons of the annotated video clip pairs, the Bradley-Terry model may derive full rankings of each video clip. In this way, the processor 102 may rank each video clip in terms of the obligation level, effort level, and satisfaction level.

In the process of the labeling 310, the processor 102 may generate labels for the video clips in the multi-level categorical labels for each of the obligation, effort, and satisfaction. As an example, out of 466 video clips, the top 155 video clips ranked from the 1st to 155th may be classified as those of a high level of obligation; the subsequent 155 videos ranked from the 156th to 310th may be set as a medium level of obligation; and the remaining 156 video clips ranked from 311th to 466th, may be categorized as a low level of obligation. Similarly, the 466 video clips may be classified into one of the three levels in terms of effort and satisfaction based on their rankings.

Once the video clips are labeled with one of multi-level categories for each of the obligation, effort and satisfaction, the same labeled categories may be applied consistently across each of the gaze features, physiological features, gaze sematic features and CAN bus features based on the timestamps.

For example, when a video clip from 1 h:2 m:0 s to 1 h:2 m:5 s has been classified into a low-level obligation and high levels of effort and satisfaction, the other extracted features of the same time period also have the same classification categories: a low level obligation, a high level of effort, and a high level of satisfaction.

In the LLM-based feature extraction 312, the mobility system 100 may utilize the reasoning and contextual understanding capabilities of LLMs to extract features indicative of prosocial behaviors from images. As an example, the mobility system 100 may employ a generative pre-trained transformer (GPT) to analyze and extract features from the dataset 302. According to one aspect, the contextual features may be extracted from the forward video by a LLM, such as GPT-4, for example. If video clips are incompatible with the LLM API's direct processing capabilities, the processor 102 may decompose the video clips into a series of image frames.

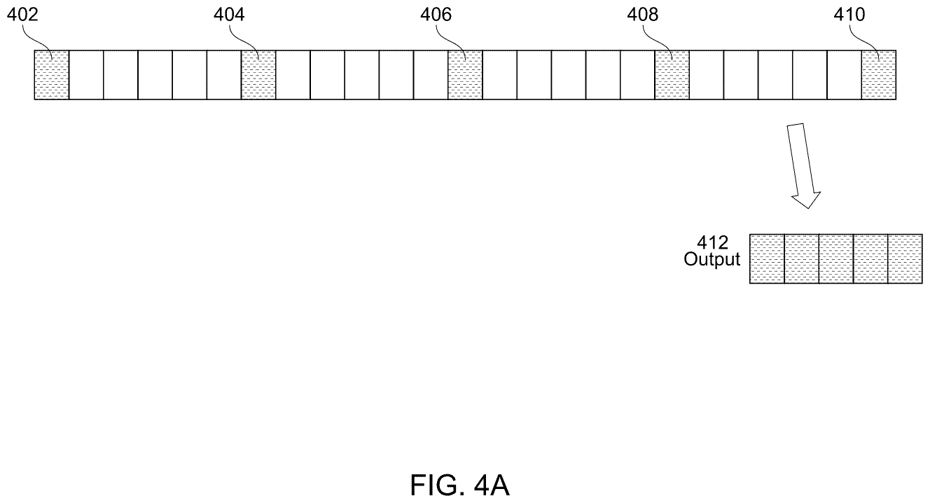

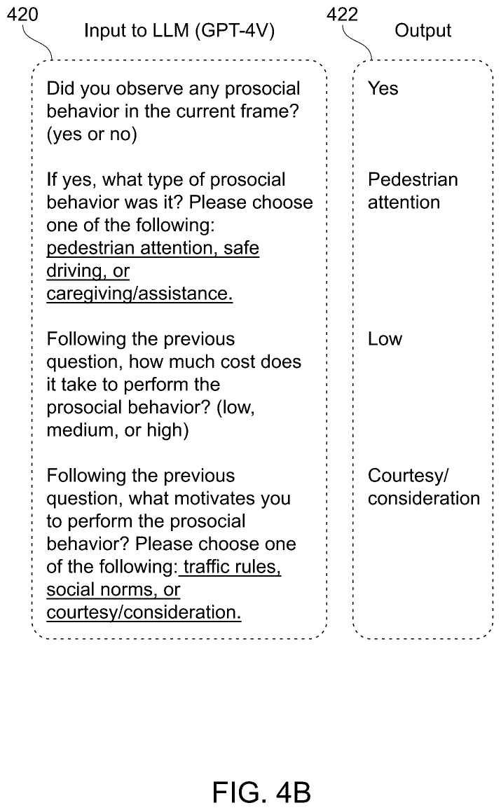

FIG. 4A illustrates an exemplary series of image frames decomposed from video clips for the LLM-based feature extraction 312, according to one aspect. As shown, each of image frames 402, 404, 406, 408, 410 may be extracted at every interval, such as 0.8 seconds, which results in five frames per video clip for the output frames 412. This decomposition method adapts to the varying lengths of video clips, ensuring the first and last frames of the video may be included, with evenly spaced frames in between. Once the image frames are extracted, these frames may be fed into the LLM 112 for analysis and feature extraction.

FIG. 4B illustrates an exemplary set of questions (e.g., a query) for an LLM to extract contextual features from image frames of video clips and their outputs, according to one aspect. The processor 102 may query the LLM 112 with a set of questions 420 supplemented with definitions of prosocial behaviors to improve clarity and accuracy. As an example, “Following the previous question, how much cost does it take to perform the prosocial behavior? Please choose one of low, medium, or high”, “How much effort does it take to perform the prosocial behavior? Please choose one of low, medium, or high”, and/or “What motivates you to perform the prosocial behavior? Please choose one of the following: traffic rules, social norms, or courtesy/consideration”.

In response to the set of questions 420, the LLM 112 may return one or more outputs 422 for the image frames. The output 422 of the LLM 112 may be aligned under the predefined categories, such as whether prosocial behaviors are identified or not, the motivations (e.g., obligation, effort, or satisfaction) of the prosocial behaviors, and one of multiple levels of each of obligation, effort, and satisfaction.

For example, as the outputs in response to the type of prosocial behavior, “Pedestrian yielding” and “Pedestrian attention” may be grouped into a single category of pedestrian attention, which may be classified into obligation. Similarly, the motivations like “courtesy”, “cooperation”, “empathy”, “consideration”, and “community well-being” may be grouped under the courtesy category, which may be classified into satisfaction. Subsequently, the processor 102 may redefine the input questions into multiple choice questions where applicable to categorize the image frames and its corresponding video clip into the three-level categories in terms of obligation, effort, and satisfaction.

Referring back to the prosocial behavior detection 314 in FIG. 3, the prosocial behavior detection model 114 may be trained to detect the driver's prosocial behaviors based on the extracted multimodal signals. According to one aspect, the multimodal signals may include physiological signals, eye gaze signals, and CAN-bus signals output from the signal processing and feature extraction 304, the multi-level categorical label data output from the labeling 310, and the contextual features output from the LLM-based feature extraction 312.

The prosocial behavior detection model 114 may utilize various machine learning algorithms including 2D Convolutional Neural Network (CNN), 1D CNN or transformer models for the time series features, and Random Forest model or Gradient Boosted for the single window features.

In the prosocial behavior classification 316, the prosocial behavior classification model 116 may be trained to classify the detected behaviors into the multiple predefined levels of obligation, effort, and satisfaction. To do this, the prosocial behavior classification 316 may utilize a random forest tree model or a gradient boosted decision tree for single window data and CNN models or transformer models for time series data. The training data may include the multimodal extracted signals, labeled video clips, and LLM-based contextual features, each of which corresponds to the detected prosocial behaviors.

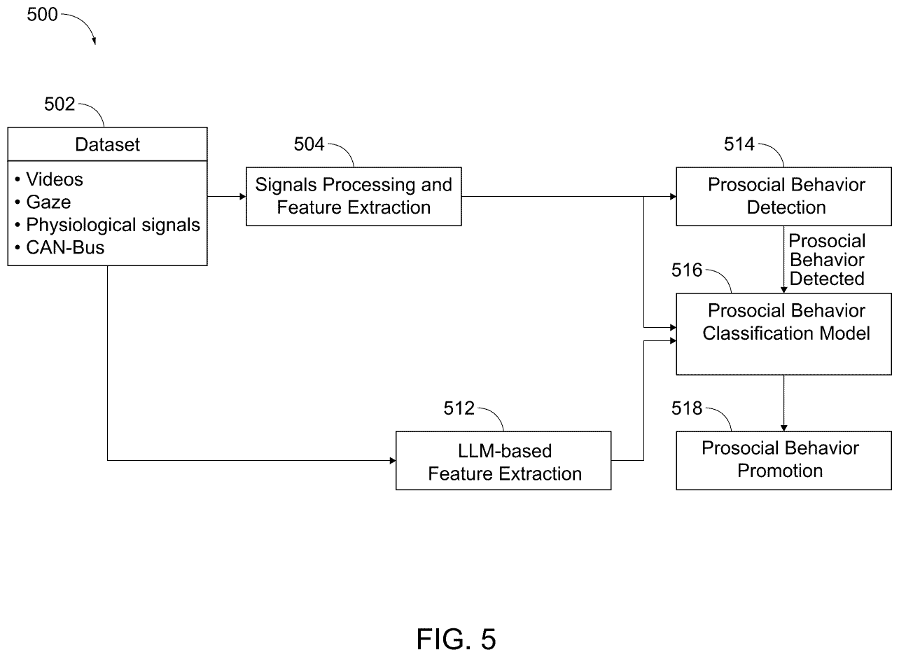

FIG. 5 illustrates an exemplary block diagram for executing the AI models for detecting and classifying prosocial behaviors in a real driving environment, according to one aspect. The mobility system 100 in the execution stage may collect the dataset 502 in real-time. With the dataset 502, the mobility system 100 may perform the signal processing and feature extraction 504, the LLM-based feature extraction 512, the prosocial behavior detection 514, and the prosocial behavior classification 516.

One difference from the training stage in FIG. 3 is that the mobility system 100 in the execution stage may not perform the video annotation, Bradley-Terry modeling, and labeling. Another difference is that the mobility system 100 may additionally perform the prosocial behavior promotion 518 to promote the prosocial behaviors.

The dataset 502 may include video data from the image capture device 120, eye gaze data from the eye tracking sensor 122, physiological data from the wearable sensor 124, and CAN-bus data via the CAN-bus 132 when a driver drives the mobility system 100 in on a road. The dataset 502 may include real-time data. The prosocial behavior detection model 114 and the prosocial behavior classification model 116 may be trained with the dataset 302 as described above in reference to FIG. 3.

In the signal processing and feature extraction 504, the processor 102 may extract the multimodal signals extracted from the real-time dataset 502. Also, in the LLM-based feature extraction 512, the LLM 112 may extract contextual features from the real-time dataset 502.

In the prosocial behavior detection 514, the prosocial behavior detection model 114 may detect the driver's prosocial behaviors based on the extracted multimodal signals and the extracted contextual features.

Once prosocial behaviors are detected, the prosocial behavior classification 516 may classify the detected prosocial behaviors into those of the multiple predefined levels (e.g., three levels) of obligation, effort, and satisfaction.

In the prosocial behavior promotion 518, the processor 102 may take various measures to promote, via the output devices 126 (e.g., display, speaker, etc.), the prosocial behaviors based on the classified levels of the psychological factors. These promotion measures may be applied concurrently based on the classification results of the prosocial behaviors.

According to one aspect, when the prosocial behavior is classified as one of a medium or higher level of obligation, the processor 102 may allow the driver to access less restrictive configurations of the mobility system 100, such as a higher level of driving assistance or autonomous driving level than the prosocial behaviors classified as obligation are not detected. When the prosocial behavior is classified as one of a medium or higher level of effort, the processor 102 may provide the driver with economical reward points in proportion to the level of effort. When the prosocial behavior is classified as one of a medium or higher level of satisfaction, the processor 102 may provide the driver with complimentary acknowledgement.

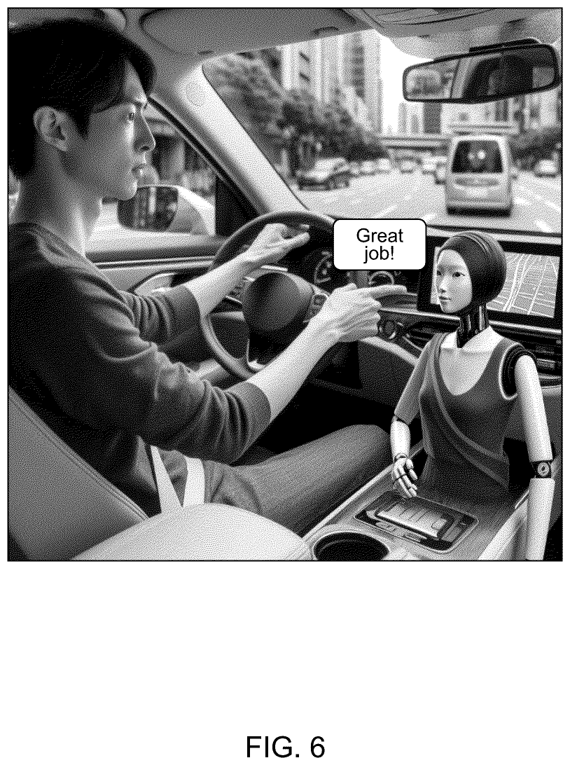

FIG. 6 illustrates an exemplary promotion measure to promote the prosocial behavior classified as one of a medium or higher level of satisfaction. As illustrated in FIG. 6, when the prosocial behavior is classified as one of a medium or higher level of satisfaction, the processor 102 may have output device 126 display various complimentary messages on a hologram or display screen or output them by voice from a speaker. In this way, the driver's self-satisfaction increases, motivating the driver to behave more prosocially.

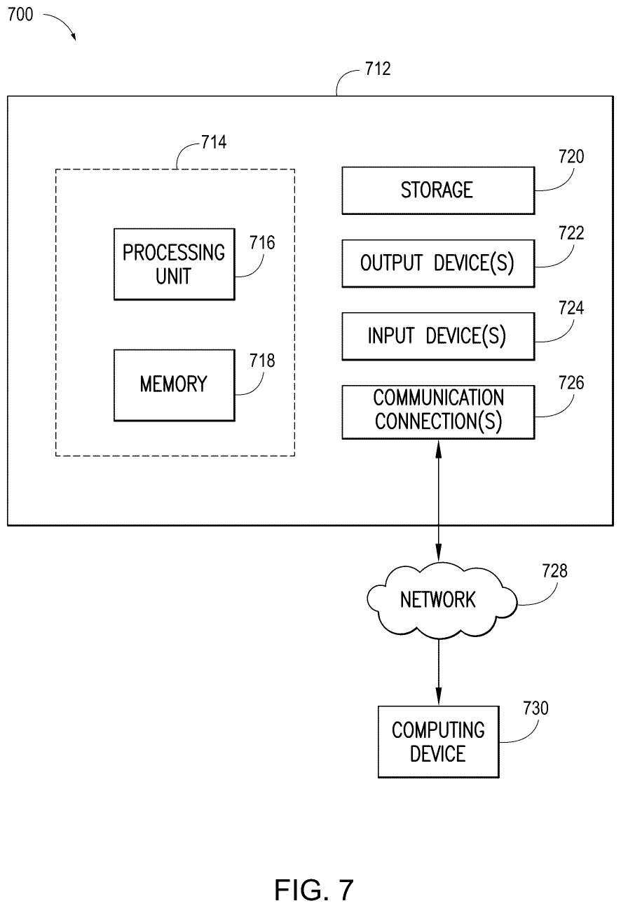

FIG. 7 illustrates a system 700 including a computing device 712 configured to implement one aspect provided herein. In one configuration, the computing device 712 includes a processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the computing device 712 includes additional features or functionality. For example, the computing device 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by the processing unit 716, for example.

The term “computer readable media” as used herein includes computer storage media. Computer storage media includes volatile and nonvolatile, removable, and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 712. Any such computer storage media is part of the computing device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 712 includes input device(s) 724 such as keyboard, mouse, pen, voice input device, touch input device, infrared cameras, video input devices, or any other input device. Output device(s) 722 such as one or more displays, speakers, printers, or any other output device may be included with the computing device 712. Input device(s) 724 and output device(s) 722 may be connected to the computing device 712 via a wired connection, wireless connection, or any combination thereof. In one aspect, an input device or an output device from another computing device may be used as input device(s) 724 or output device(s) 722 for the computing device 712. The computing device 712 may include communication connection(s) 726 to facilitate communications with one or more other devices 730, such as through network 728, for example.

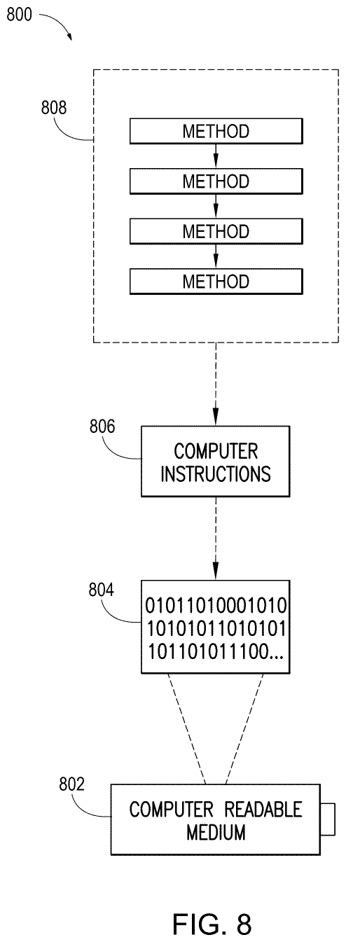

Still another aspect involves a computer-readable medium including processor-executable instructions configured to implement one aspect of the techniques presented herein. An aspect of a computer-readable medium or a computer-readable device devised in these ways is illustrated in FIG. 8, wherein an implementation 800 includes a computer-readable medium 802, such as a CD-R, DVD-R, flash drive, a platter of a hard disk drive, etc., on which is encoded computer-readable data 804. This encoded computer-readable data 804, such as binary data including a plurality of zero's and one's as shown in 804, in turn includes a set of processor-executable computer instructions 806 configured to operate according to one or more of the principles set forth herein. In this implementation 800, the processor-executable computer instructions 806 may be configured to perform a method 808, such as processes conducted by the processor 102 and the AI models of FIG. 1, including the computer-implemented method 200 of FIG. 2 or the computer-implemented method 300 of FIG. 3. In another aspect, the processor-executable computer instructions 806 may be configured to implement a system, such as the mobility system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A mobility system for detecting and classifying a prosocial behavior of a driver driving a vehicle, comprising:
a memory storing one or more instructions; and
a processor executing one or more of the instructions stored on the memory to perform:
collecting a dataset from at least one sensor;
extracting multimodal features and contextual features from the dataset;
detecting, by a first AI model, a prosocial behavior of the driver based on the extracted multimodal features;
classifying, by a second AI model, the detected prosocial behavior into a respective one of a plurality of levels of each of a plurality of psychological factors linked to the detected prosocial behavior; and
conducting one of multiple promotion measures to promote the prosocial behavior based on a respective level of each of the plurality of the psychological factors.

2. The mobility system of claim 1, wherein
the dataset includes a forward video from an image capture device, eye gaze data from an eye tracking sensor, physiological data from a wearable sensor, and control area network (CAN) bus data from a CAN bus of the mobility system;
the extracted multimodal features include video clips, eye gaze signals, physiological signals, and CAN-bus signals; and
the contextual features are extracted from the forward video by a large language model (LLM).

3. The mobility system of claim 2, wherein
the plurality of psychological factors includes obligation, effort, and satisfaction.

4. The mobility system of claim 3, wherein
the first AI model and the second AI model are trained based on a plurality of video clips labeled with one of multi-level categories of each of the obligation, effort, and satisfaction.

5. The mobility system of claim 3, wherein
the multiple promotion measures include providing the driver with an economical reward point to the driver when the prosocial behavior is classified as one of a medium or higher level of the effort.

6. The mobility system of claim 3, wherein
the multiple promotion measures include allowing the driver to access a less restrictive configuration when the prosocial behavior is classified as one of a medium or higher level of obligation.

7. The mobility system of claim 3, wherein
the multiple promotion measures include providing the driver with a complimentary acknowledgement to the driver when the prosocial behavior is classified as one of a medium or higher level of the satisfaction.

8. A computer-implemented method for detecting and classifying a prosocial behavior of a driver driving a vehicle, comprising:
collecting a dataset from at least one sensor;
extracting multimodal features and contextual features from the dataset;
detecting, by a first AI model, a prosocial behavior of the driver based on the extracted multimodal features;
classifying, by a second AI model, the detected prosocial behavior into a respective one of a plurality of levels of each of a plurality of psychological factors linked to the detected prosocial behavior; and
conducting one of multiple promotion measures to promote the prosocial behavior based on a respective level of each of the plurality of the psychological factors.

9. The computer-implemented method of claim 8, wherein:
the dataset includes a forward video from an image capture device, eye gaze data from an eye tracking sensor, physiological data from a wearable sensor, and control area network (CAN) bus data from a CAN bus of the vehicle;
the extracted multimodal features include video clips, eye gaze signals, physiological signals, and CAN-bus signals; and
the contextual features are extracted from the forward video by a large language model (LLM).

10. The computer-implemented method of claim 8, wherein
the plurality of psychological factors includes obligation, effort, and satisfaction.

11. The computer-implemented method of claim 10, wherein
the first AI model and the second AI model are trained based on a plurality of video clips labeled with one of multi-level categories of each of the obligation, effort, and satisfaction.

12. The computer-implemented method of claim 10, wherein
the multiple promotion measures include providing the driver with an economical reward point to the driver when the prosocial behavior is classified as one of a medium or higher level of the effort.

13. The computer-implemented method of claim 10, wherein
the multiple promotion measures include allowing the driver to access a less restrictive configuration when the prosocial behavior is classified as one of a medium or higher level of obligation.

14. The computer-implemented method of claim 10, wherein
the multiple promotion measures include providing the driver with a complimentary acknowledgement to the driver when the prosocial behavior is classified as one of a medium or higher level of the satisfaction.

15. The computer-implemented method of claim 8, wherein
the second AI model utilizes a random forest tree model or a gradient boosted decision tree.

16. A non-transitory computer readable storage medium storing instructions that when executed by a computer having a processor to perform a computer-implemented method for detecting and classifying a prosocial behavior of a driver driving a vehicle, the computer-implemented method comprising:
collecting a dataset from at least one sensor;
extracting multimodal features and contextual features from the dataset;
detecting, by a first AI model, a prosocial behavior of the driver based on the extracted multimodal features;
classifying, by a second AI model, the detected prosocial behavior into a respective one of a plurality of levels of each of a plurality of psychological factors linked to the detected prosocial behavior; and
conducting one of multiple promotion measures to promote the prosocial behavior based on a respective level of each of the plurality of the psychological factors.

17. The non-transitory computer readable storage medium of claim 16, wherein
the plurality of psychological factors includes obligation, effort, and satisfaction.

18. The non-transitory computer readable storage medium of claim 17, wherein
the multiple promotion measures include providing the driver with an economical reward point to the driver when the prosocial behavior is classified as one of a medium or higher level of the effort.

19. The non-transitory computer readable storage medium of claim 17, wherein
the multiple promotion measures include allowing the driver to access a less restrictive configuration when the prosocial behavior is classified as one of a medium or higher level of obligation.

20. The non-transitory computer readable storage medium of claim 17, wherein
the multiple promotion measures include providing the driver with a complimentary acknowledgement to the driver when the prosocial behavior is classified as one of a medium or higher level of the satisfaction.
